(19) United States
(12) Patent Application Publication
(10) Pub. No.: US 2013/0159037 A1
(43) Pub. Date: Jun. 20, 2013

(54) MULTILEVEL VISUALIZATION OF SCENARIO MODELS AND SCENARIO INSTANCES

(71) Applicants: Ulrich Keil, Heidelberg (DE); Joachim Fessler, Grafenberg (DE); Jochen Mayerle, Flein (DE); Uwe Schulz, Flein (DE); Marianne Brosche, Heidelberg (DE); Holger Knospe, Wiesloch (DE)

(72) Inventors: Ulrich Keil, Heidelberg (DE); Joachim Fessler, Grafenberg (DE); Jochen Mayerle, Flein (DE); Uwe Schulz, Flein (DE); Marianne Brosche, Heidelberg (DE); Holger Knospe, Wiesloch (DE)

(21) Appl. No.: 13/326,254

(22) Filed: Dec. 14, 2011

(51) Int. Cl. G06Q 10/06

(52) U.S. Cl. 705/7.12

(57) ABSTRACT

A single meta-model can include metadata defining a business scenario landscape that includes business scenarios accessible to members of an organization that are supported by a business software architecture. The metadata can include business process definitions and relationships between business processes. A user interface can present first, second, and/or third visualization layers based on the metadata. The first visualization layer can include first user interface elements forming a business scenario landscape map showing business scenarios and at least one relationship between the business scenarios. The second visualization layer can include second user interface elements displayed in a navigation pane concurrently with a work pane. The second user interface elements can represent a linear sequence of second business processes of a business scenario while the work pane can include additional user interface elements corresponding to functionality provided by the business software architecture relating to a currently selected business process.

### CROSS-REFERENCE TO RELATED APPLICATIONS

The current application is related to the following co-pending and co-owned U.S. patent applications, the disclosure of each of which is incorporated herein in its entirety: [[Attorney docket nos. 34874-774F01US/2011P00201US, 34874-760F01US/2011P00149US, 34874-761F01US/2011P00163US, 34874-763F01US/2011P00166US, 34874-764F01US/2011P00167US, 34874-765F01US/2011P00168US, 34874-766F01US/2011P00169US, 34874-768F01US/2011P00171US, 34874-769F01US/2011P00172US, 34874-770F01US/2011P00173US, 34874-772F01US/2011P00175US, 34874-773F01US/2011P00198US, and 34874-781F01US/2011P00363US]].

### TECHNICAL FIELD

The subject matter described herein relates generally to enhancing user interaction with, and navigation among, features, functions, controls, and the like of an integrated software suite, such as for example an enterprise resource planning solution.

### BACKGROUND

The inherent complexity of business processes and their implementation in business software solutions, enterprise resource planning (ERP) systems, and the like can present substantial challenges to users and can be a serious obstacle to widespread operative use of process models in the software landscape. A wealth of highly technical process modeling notations (e.g. business process modeling notation (BPMN) editors and process engines, enhanced process chains (EPC), modeling hierarchies built on these or similar model types, etc.) is currently available for use in technical systems. However, these types of resources are typically difficult for a non-technical user to understand and use. While numerous non-technical tools exist for depicting high-level processes (e.g. drawing, mind-map, or presentation tools or the like), such tools typically lack any operative connection with the underlying transactional data relating to specific instances of business processes in a business software architecture and therefore can provide only a picture of an idealized concept of a business process.

### SUMMARY

In one aspect, a computer-implemented method includes accessing a single meta-model that includes metadata defining a business scenario landscape. The business scenario landscape includes a plurality of business scenarios accessible to members of an organization and supported by a business software architecture. The metadata include business scenario definitions and relationships between business scenarios in the business scenario landscape. A first visualization layer based on the metadata is presented via a user interface. The first visualization layer includes first user interface elements forming a business scenario landscape map showing at least two of the plurality of business scenarios and at least one relationship between the at least two of the plurality of business scenarios. Upon receiving a navigation command entered via one or more of the plurality of first user interface elements, a second visualization layer based on the metadata is presented via the user interface. The second visualization layer includes a plurality of second user interface elements displayed in a navigation pane concurrently with a work pane. The plurality of second user interface elements are arranged in a linear progression to represent a linear sequence of a plurality of business processes and/or process steps of one of the plurality of business scenarios. The work pane includes a plurality of additional user interface elements corresponding to functionality provided by one or more feature modules of the business software architecture related to a currently selected one of the plurality of second business processes and/or process steps.

In some variations one or more of the following features can optionally be included in any feasible combination. The at least one relationship between the at least two of the plurality of business scenarios can optionally include one or more of a business scenario intersection relationship, a business scenario dependency relationship, a business scenario prerequisite relationship, and a business scenario predecessor-successor relationship. The first user interface elements can optionally be arranged in the first visualization layer to form a scenario-centric view in which a currently active business scenario of the at least two of the plurality of business scenarios is arranged approximately centrally in a view of the first visualization layer and with those of the plurality of first user interface elements representing the business processes and/or process steps of the currently active business scenario arranged substantially centrally and in a linear succession to show a linear ordering of the business processes and/or process steps and in which others of the at least two of the plurality of business scenarios are arranged to show the at least one relationship to the currently active business scenario. The plurality of first user interface elements can optionally be arranged in the first visualization layer to form a transit map view of the business scenario landscape in which each of the at least two of the plurality of business scenarios are shown as linearized scenarios represented by a plurality of stops each representing a business process and/or process step that is part of one or more of the at least two of the plurality of business scenarios and a linear route linking at least some of those business processes and/or process steps that are part of each of the at least two of the plurality of business scenarios.

The single meta-model further can optionally include at least one of concrete data, detailed instance information, a key performance indicator, configuration information, and an organizational reference. The concrete data, detailed instance information, the key performance indicator, configuration information, and the organizational reference can optionally be associated with at least one of an in-progress instance of one of the plurality of business scenarios and a completed instance of one of the plurality of business scenarios. At least one of the plurality of first user interface elements and the plurality of second user interface elements can optionally provide a visual indicator of a current status of a corresponding process step in the in-progress and/or completed instance of the business process. Upon receiving a navigation command entered via one or more of the plurality of first user interface elements or one or more of the plurality of second user interface elements, a third visualization layer based on the metadata can optionally be presented via the user interface. The third visualization layer can optionally include a plurality of third user interface elements arranged to display a full detail view of the currently active business scenario or of a business process within the currently active business scenario.

Implementations of the current subject matter can include, but are not limited to, systems and methods consistent including one or more features are described as well as articles that comprise a tangibly embodied machine-readable medium operable to cause one or more machines (e.g., computers, etc.) to result in operations described herein. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

Implementations of the current subject matter can provide one or more advantages. For example, business process management (BPM) information can be made available not just to “business process experts,” but can instead serve all users of a business software system. Multiple levels (e.g. at least three levels in some implementations) of abstraction layers representing business scenario and/or business process features and interactions at increasing levels of detail and complexity can be seamlessly visualized using an integrated tool. Inter-scenario relationships, overviews of specific business scenarios in a simplified linearized view, and business scenario structures showing full details of each business process underlying a business scenario can be linked and dynamically navigable to represent a business scenario template for each business scenario and for the scenario landscape as a whole and also to visually display one or more progress and/or completion details for specific business scenario instances. A multi-layer abstraction structure featuring an attractive and informative but not overly complex visual representation can guide a user with any of a variety of technical and/or business proficiencies, beginner to expert skill levels, and specialist to generalist roles through an organization's defined business scenarios as well as a record of specific individual instances of those business scenarios in either a structured path through defined scenarios or with a creative approach (e.g. designing new scenarios or modifying existing scenarios and integrating the features of these business scenarios with system capabilities). Using this approach, business scenario and business process information can be made ubiquitous as it can readily provide the degree of detail appropriate for the task at hand.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an enterprise resource software system or other business software solution or architecture, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 shows a screenshot of a user interface illustrating a scenario landscape overview view;

FIG. 2 shows another screenshot of a user interface illustrating a linear single business process view;

FIG. 3 shows another screenshot of a user interface illustrating a structured business process detail view;

FIG. 4 is a process flow diagram illustrating aspects of a method having one or more features consistent with implementations of the current subject matter;

FIG. 5 is a diagram illustrating aspects of a system showing features consistent with implementations of the current subject matter;

FIG. 6 is a diagram illustrating aspects of a system showing features consistent with implementations of the current subject matter; and

FIG. 7 is a diagram illustrating a data repository showing features consistent with implementations of the current subject matter.

When practical, similar reference numbers denote similar structures, features, or elements.

### DETAILED DESCRIPTION

The complexity of modern business software solutions can prevent full realization and use of the value of these tools. It is very difficult to make business process technology truly accessible, appealing, and useful using only a stand-alone, non-integrated visualization or overview map. Rather, there is a need for a structured and variably detailed abstraction model that can present the dozens to thousands of objects, systems, rules, events, relationships and persons involved in a realistic, operational business scenario in a manner that preserves overview without losing essential detail.

To address these and potentially other issues with currently available solutions, methods, systems, articles of manufacture, and the like consistent with one or more implementations of the current subject matter can, among other possible advantages, provide a multi-level abstraction layer structure via which a user can access increasing levels of complexity and detail regarding any of the business scenarios included in an organization's scenario landscape. In this manner, the user can access information about the scenario landscape, individual business scenarios and business processes within the scenario landscape, and specific instances of those business scenarios and business processes via an integrated interface that provides a necessary balance between overview and detail.

As used herein, the term “scenario landscape” refers to a set including all or some of the business scenarios characterizing an organization's operations. The business scenarios can be managed, and tasks relating to the completion of one or more steps of the business scenarios can be supported by, one or more feature modules of a business software architecture, such as for example an enterprise resource planning (ERP) system. The term “instance of a business scenario” and similar descriptive terminology is intended to refer to a specific execution of the business scenario. For example, for a business scenario relating to sale of a product, each order taken and filled for that product can be considered as an instance of the business process.

Business scenario information can be efficiently broken down into a uniform structure that makes it consumable for all users of a system, for example for non-technical users; allows tool builders to design attractive visualization and editing tools separately for each level; fosters communication about business process models across departments, for example between technical and business-focused departments that typically have to find a common agreement of a business process in order to implement it; and removes the necessity for model transformations, which can be complex and time consuming, as all information about a business scenario can be contained in a single meta-model. The abstraction levels can be linked such that changes on one level cannot invalidate other levels, but rather, a change on one level of the abstraction model can be immediately reflected on all other levels assuming that a level of detail is present on another level to reflect the change. For example, a change to a high level overview can create or modify a shell feature on a more detailed level into which additional detail can be added. On the other hand, a minor change to a feature at a lower, more detailed level of the abstraction model might not affect a view at a higher overview level if the modified or added or deleted feature was not directly shown at that level due to the reduced level of detail presented in the overview. All model levels, even the pure overview level, which in currently available solutions is typically captured with drawing tools external to the business software architecture, can be presented as linked operative models that allow a drill down to any level of detail and even to operative execution.

In an implementation, abstraction layers of a business scenario landscape abstraction model can include one or more of a scenario overview map, a linear single scenario view, and a structured scenario or process detail view. Navigation between these views can be provided by typical user interface links. For example, clicking or selecting an icon in one view can link to a relevant and related feature in one of the other layers. Further details regarding this feature are discussed below. In some implementations, a single meta-model can be used to define the information required to extract and render the model details required on each of the three (or more or fewer) levels of the abstraction model. Having a single meta-model can be advantageous in avoiding inconsistencies that otherwise (e.g. by using unrelated models per level) would be very hard to prevent. With individual models per level, navigation and cross-checks would be much harder to implement.

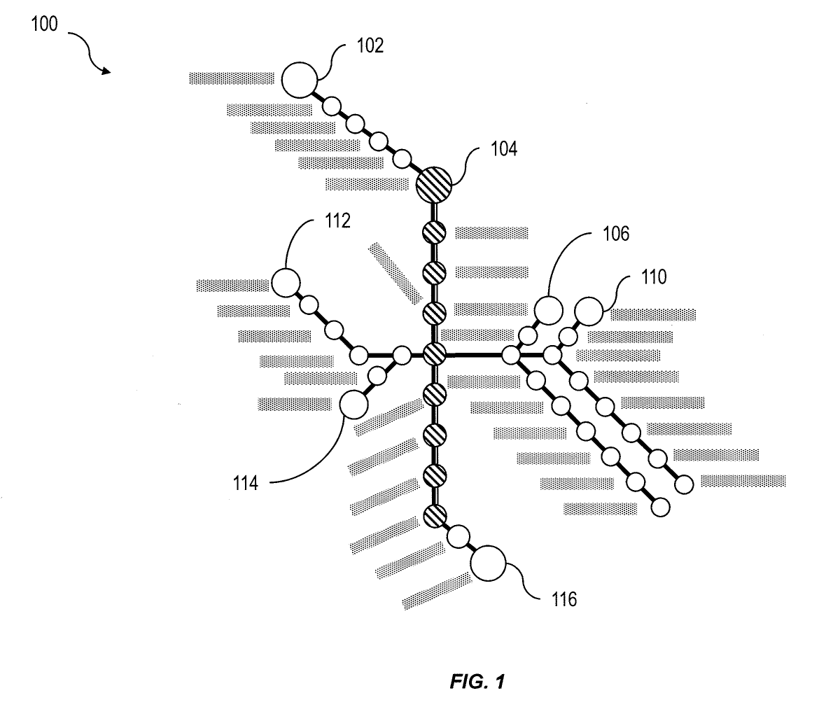

FIG. 1 illustrates an example of a scenario landscape overview map 100, which includes relational links between a plurality of business scenarios in a scenario landscape. Each of several business scenarios 102, 104, 106, 110, 112, 114, 116 are shown at a linear overview degree of detail to depict the relations between the different business process 102, 104, 106, 110, 112, 114, 116 in the scenario landscape. In an implementation, the overview map can be modeled as a transit map that shows the place and the function of each business scenario in the scenario landscape as a whole. Intrinsic relation types between the business scenarios 102, 104, 106, 110, 112, 114, 116 can include, but are not limited to, a predecessor scenario or process, which is defined as a business scenario or process whose completion is a prerequisite to another business scenario or process (e.g. business scenario 202, which includes several business processes (shown in FIG. 1 as smaller circles) that lead to the initiation of business scenario 104); a successor scenario or process, which is defined as a business scenario or process having a predecessor scenario or process (e.g. business scenario 104, which has business scenario 102 as its predecessor scenario); a joint use scenario, which is defined as a business scenario that shares a common business process, a common process step, a common data object, a common responsible entity (e.g. a person, a unit, etc.), a common event, or the like (e.g. business scenarios 106 and 110, which share business processes with business scenario 112; or business scenario 116 and business scenario 104, which share a business process); and a hierarchical use process, which is defined as a business process that uses another business process as a sub-process (e.g. business scenario 112, which includes as a branching business scenario the business scenario 114). Also as shown in FIG. 1, the business scenarios and/or the included business processes can be labeled in a manner similar to stops on a transit map.

The scenario landscape overview map 100 can advantageously be arranged in a scenario-centric manner, for example such that a specific, currently active business scenario 104 is arranged approximately centrally in the overview diagram with other related business scenarios (e.g. including but not limited to the business scenario relationships explained in the preceding paragraph) shown branching or intersecting with the currently active business scenario 104. The scenario overview map 100 can also advantageously include one or more visual cues to indicate information about the various business scenarios and/or the business processes shown in the scenario overview map 100. For example, the route line 120 of the currently active business scenario 104 can be shown in a different thickness, with a different pattern, in a different color or brightness, or the like, and the business processes of the currently active business scenario 104 can likewise be shown with a different pattern, color, brightness, etc. Clicking on a business process of the currently active business scenario 104 can directly navigate a user to a linear single scenario view of the currently active business scenario displayed simultaneously with a work space including user interface elements related to completion, monitoring, etc. of a selected business process within the business scenario. Clicking on a business process of another business scenario besides the currently active business scenario 104 can cause the scenario overview map 100 to rearrange to show the scenario landscape with a new scenario-centric view based on the newly selected business scenario.

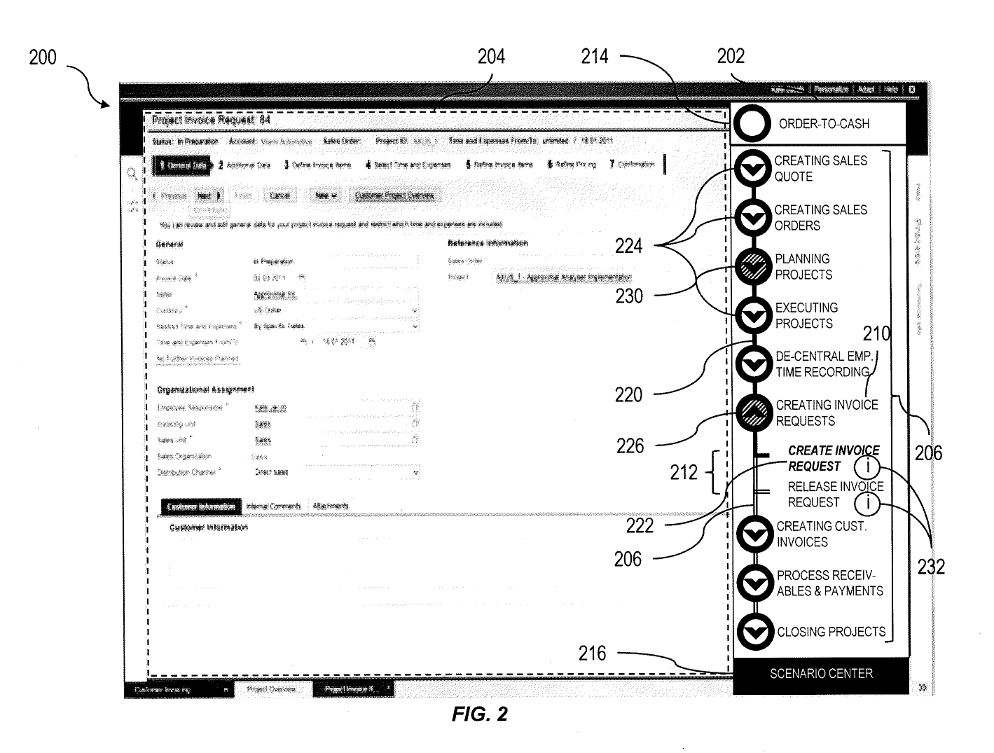

FIG. 2 illustrates an example of a linear single scenario view 200, which shows a single business scenario as a linear sequence of business processes 202 and/or process steps 204, which can in turn include additional tasks or process sub-steps. The structure of the business scenario is condensed into a linear view, even though the actual flow of tasks and other actions necessary to complete an instance of the business scenario often involves explicit parallelism, decisions, loops, event driven changes in control flow, exceptions, and the like. Consistent with the scope of the current subject matter, any viable approach can be used to shape a business scenario into such a linear view.

As shown in FIG. 2 a scenario navigation pane 202 and a work pane 204 are concurrently displayed. A plurality of first user interface elements 206 are displayed in the scenario navigation pane 202 and arranged in a linear progression to represent the linear sequence of process steps in the process model of the currently actively business process. A first user interface element 210 corresponding to a business process 206 having additional process steps can be expanded as shown in FIG. 2 to display additional user interface elements 212 corresponding to the process steps. Also as shown in FIG. 2, the currently active business scenario can be identified by one or more scenario identifier user elements 214. A scenario browser user interface element 216 can link to the upper level scenario landscape overview map 100 to display an overall scenario landscape map showing intersections between scenarios and providing links to navigate to the other scenarios in the scenario landscape.

The first user interface elements 206 can be displayed in a manner similar to a transit route map with each business process or process step being represented like a stop on the route. In this manner, a familiar visual format can rapidly convey additional information about a current context within a specific instance of the business scenario as well as status information about the various business processes that form the “route” to completion of the instance of the business scenario. For example, a route line 220 connecting the “stops” can be presented with a first visual effect (e.g. color, brightness, shade, dots or dashes, etc.) up to the “stop” representing the business process that is currently “active” with related functionality being provided in the work pane 204. The currently active business process can be further indicated using textual or visual cues, such as for example color, shading, font, a highlighting box, etc. As a non-limiting example, the name of the business process displayed in conjunction with the user interface element 222 corresponding to the currently active business process in FIG. 2 is formatted in a bold and italicized font. A different second visual effect can be used for the route line 220 leading to the “stops” past the currently active business process. The icons 224 used to represent the “stops” in the scenario navigation pane can also include visual cues to inform a user about status, other business processes that are included within the currently displayed business process user interface elements and that can be revealed by a user action to expand the route map, or the like.

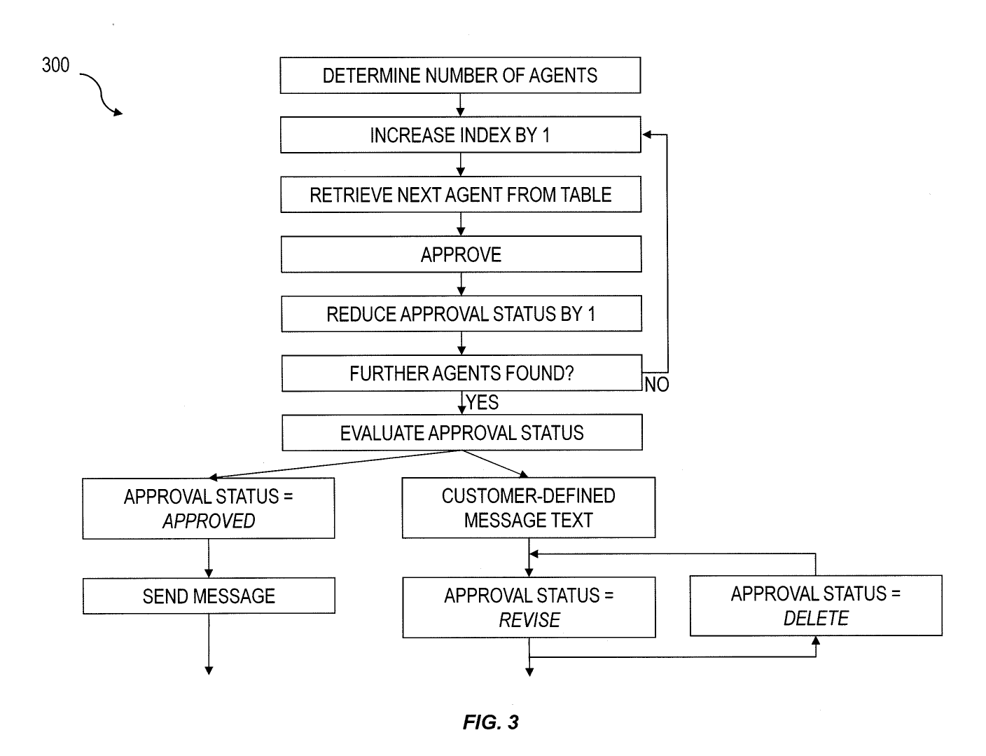

Also in the example shown in FIG. 2, the expanded business process 210 is also an intersecting business process that includes additional process steps that are part of a second business process. The additional process steps are illustrated by first user elements 212 incorporated directly into the route map without branching to maintain the linear progression of the scenario model. The first user interface element 226 representing the “stop” corresponding to this business process can include a different visual presentation than other non-intersecting “stops” and can further include other visual presentation features to indicate that it is currently expanded as shown in FIG. 2. The “stop” first user interface element 230 corresponding to another intersecting business process (e.g. planning projects in the example of FIG. 3) can include features indicating that it is an intersecting business process with expandability, but that it currently is not expanded. Additional first user interface elements 232 (e.g. the “i” icons shown in FIG. 3) can provide additional details about one or more of the business processes. For example, selection by user of one of these additional user interface elements 232 can cause the user interface to navigate to present a third visualization layer that includes a structured business scenario or business process detail view 300.

FIG. 3 shows an illustrative example of a structured business scenario or business process detail view 300, which shows the structure of a business scenario or business process, for example using a chosen modeling paradigm (e.g. a flow paradigm, a rule based paradigm, a data flow based paradigm, etc.). On this level of the abstraction model, each business process or process step, task, etc. can be displayed (opened) inline or via navigation so as to allow drill-down to the level of elementary activities (process steps) and their artifacts like data objects, responsibility rules, events, etc. This level of the abstraction layer can be implemented using a conventional visualization model, such as for example business process diagrams (BPDs) or flow charts created with business process model and notation (BPMN), unified modeling language (UML), event-driven process chains (EPCs), etc.

Seamless navigation between adjacent levels, for example between the scenario landscape overview map 100, the linear single scenario view 200, and the structured business scenario or business process detail view 300, can be provided to ensure availability of more detail (e.g. by navigating downward) and more overview (e.g. by navigating upward) without overloading any individual level. Because a single, unified underlying meta-model provides the basis for all levels of the abstraction model from which each view layer 100, 200, 300 is fed and rendered, introduction of inconsistencies between different levels can be avoided. The metadata can be linked and can be automatically checked. It should be understood by one of ordinary skill in the art that use of the term “single” in descriptions of the meta-model does not preclude implementations in which multiple linked modules of a meta-model are unified according to a predefined structure such that the linked modules act as a single meta-model

Implementations of the current subject matter as described herein can be used for the visualization of scenario models (e.g. templates or the like for business scenarios) as well as for the visualization of concrete scenario instances, for example to illustrate the current status of a specific instance of a given business scenario. Inclusion of this feature can incorporate one or more features as described in one or more of the related co-pending and co-owned U.S. patent application listed in the first paragraph of this specification.

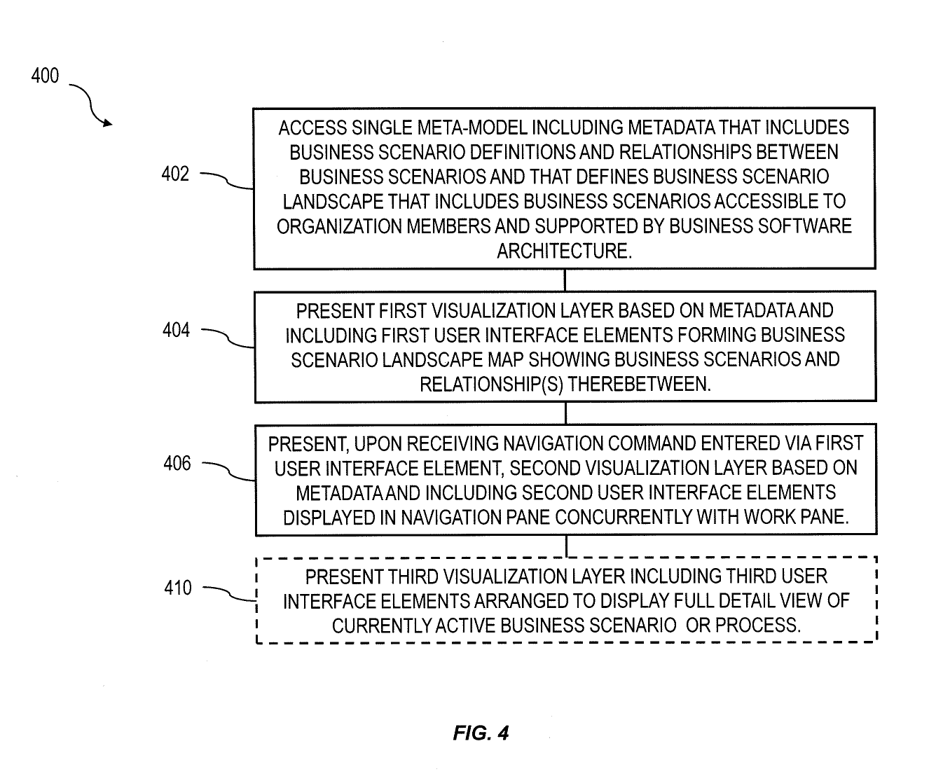

FIG. 4 shows a process flow chart 400 illustrating a method having one or more features consistent with implementations of the current subject matter. At 402, a single meta-model that includes metadata defining a business scenario landscape and, optionally, concrete data associated with at least one of an in-progress instance of one of the plurality of business scenarios and a completed instance of one of the plurality of business scenarios is accessed. The business scenario landscape includes a plurality of business scenarios accessible to members of an organization and supported by a business software architecture. The metadata include business scenario definitions and relationships between business scenarios in the business scenario landscape and can optionally include definitions of business processes, process steps, user roles, permissions, business objects, or the like. At 404, a first visualization layer based on the metadata is presented via a user interface. The first visualization layer includes a plurality of first user interface elements forming a business scenario landscape map showing at least two of the plurality of business scenarios and at least one relationship between the at least two of the plurality of business scenarios. At 406, upon receiving a navigation command entered via one or more of the plurality of first user interface elements, a second visualization layer based on the metadata is presented via a user interface. The second visualization layer includes a plurality of second user interface elements displayed in a navigation pane concurrently with a work pane. The plurality of second user interface elements are arranged in a linear progression to represent a linear sequence of a plurality of second business processes and/or process steps of one of the plurality of business scenarios. The work pane includes a plurality of additional user interface elements corresponding to functionality provided by one or more feature modules of the business software architecture related to a currently selected one of the plurality of second business processes. The at least one relationship between the at least two of the plurality of business scenarios can optionally include one or more of a business scenario intersection relationship, a business scenario dependency relationship, a business scenario prerequisite relationship, and a business scenario predecessor-successor relationship.

At 410, a third visualization layer based on the metadata is optionally presented via the user interface, for example upon selection by one or more of the plurality of user interface elements indicating availability of additional detail about the currently active business scenario. The third visualization layer includes a plurality of third user interface elements arranged to display a full detail view of the currently active business scenario or optionally, a specific business process within the business scenario. The concrete data that can optionally be included in the single meta-model can be used in some implementations to enable at least one of the plurality of first user interface elements and the plurality of second user interface elements to provide a visual indicator of a current status of a corresponding process step in the in-progress and/or completed instance of the business scenario.

A user may need or desire to access detailed business process or business scenario implementation information for a variety of reasons. For example, a user with administrative or other similar access or a corresponding role may use the detailed business process or business scenario information in the third visualization layer to implement a business scenario (e.g. a new scenario or a change to an existing scenario) in a technical system (e.g. at design time) or alternatively or in addition for business process or business scenario monitoring, error analysis, tracking activities etc. A different user role (e.g. developer, administrator, support agent) may perform one or more of these activities. The model hierarchy displayed via the third visualization layer can be used (and navigated within) from any starting point and in any direction, depending on the user intentions and/or needs. As a purely illustrative and non-limiting example, a developer might use the most detailed third visualization layer as a starting point and move progressively “upwards” in the navigation hierarchy so as to understand the end-to-end scenario he or she is working on and to see how it is embedded within the scenario landscape, and how it interacts with other scenarios within the scenario landscape.

A scenario visualization tool as described herein can be used as a basis for visualization of any kind of process relevant information, including but not limited to one or more of current status information related to in-progress and/or completed instances of a business scenario; key performance indicators (KPIs), such as (e.g. average) operation time of a process step, business process, or business scenario or between specific points within a business scenario; configuration information (e.g. what is currently in use by the organization), and organizational references (e.g. which person or role or business unit, etc. is responsible for specific aspects of business scenario, business process, or process step based on a corresponding annotation of the meta model with links to the respective entities).

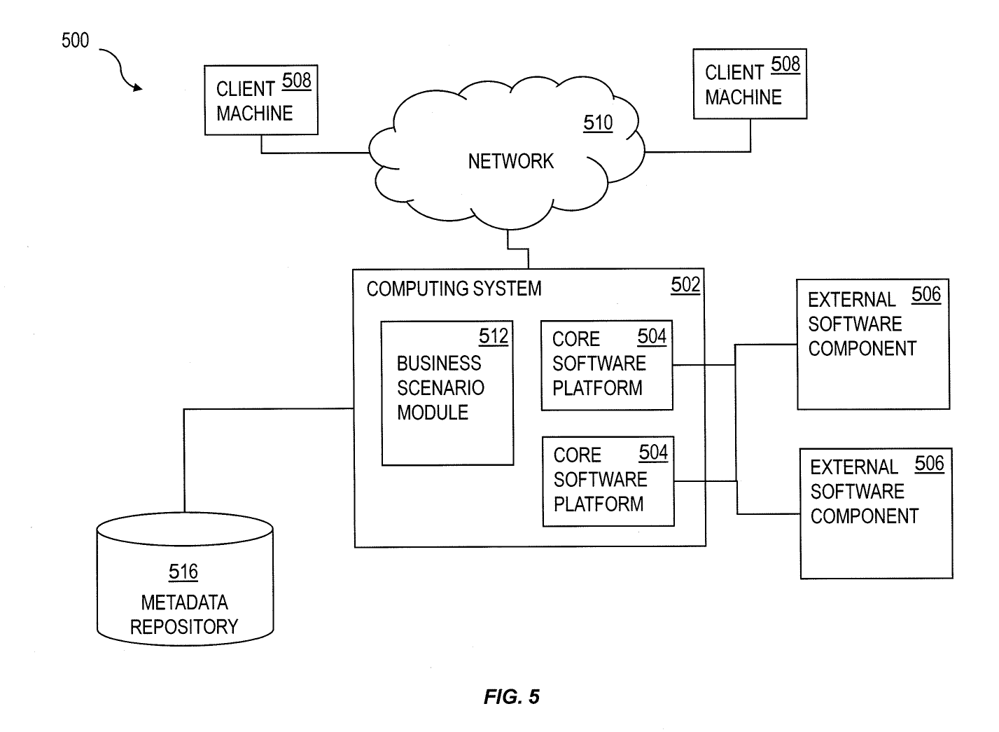

The core software platform of an ERP software architecture can be provided as a standalone, customized software installation that runs on one or more processors that are under the control of the organization. This arrangement can be very effective for a large-scale organization that has very sophisticated in-house information technology (IT) staff and for whom a sizable capital investment in computing hardware and consulting services required to customize a commercially available ERP solution to work with organization-specific business processes and functions is feasible. FIG. 5 shows a diagram of a system consistent with such an implementation. A computing system 502 can include one or more core software platform modules 504 providing one or more features of the ERP system. The computing system can also aggregate or otherwise provide a gateway via which users can access functionality provided by one or more external software components. Client machines 508 can access the computing system, either via a direct connection, a local terminal, or over a network 510 (e.g. a local area network, a wide area network, a wireless network, the Internet, or the like). A business scenario guidance and recording module 512 can be hosted on the computing system 502 or alternatively, on an external system accessible over a network connection. The business scenario guidance and recording module 512 can optionally include one or more discrete software and/or hardware modules that perform operations such as those described herein.

The business scenario guidance and recording module 512 can access one or more metadata repositories 516 and/or other data repositories that can store the definition of business process as well as data relating to concrete instances of the data objects (e.g. business objects) that are relevant to a specific instance of the business process. In some examples, the definition can optionally be stored as a business object. In some implementations, the business object can include a template definition of a standard business process. The template definition that can optionally be modified via one or more extensions that are stored in the one or more metadata repositories 516.

Smaller organizations can also benefit from use of ERP functionality. However, such an organization may lack the necessary hardware resources, IT support, and/or consulting budget necessary to make use of a standalone ERP software architecture product and can in some cases be more effectively served by a software as a service (SaaS) arrangement in which the ERP system architecture is hosted on computing hardware such as servers and data repositories that are maintained remotely from the organization's location and accessed by authorized users at the organization via a thin client, such as for example a web browser, over a network.

In a software delivery configuration in which services of an ERP system are provided to each of multiple organizations are hosted on a dedicated system that is accessible only to that organization, the software installation at the dedicated system can be customized and configured in a manner similar to the above-described example of a standalone, customized software installation running locally on the organization's hardware. However, to make more efficient use of computing resources of the SaaS provider and to provide important performance redundancies and better reliability, it can be advantageous to host multiple tenants on a single system that includes multiple servers and that maintains data for all of the multiple tenants in a secure manner while also providing customized solutions that are tailored to each tenant's business processes.

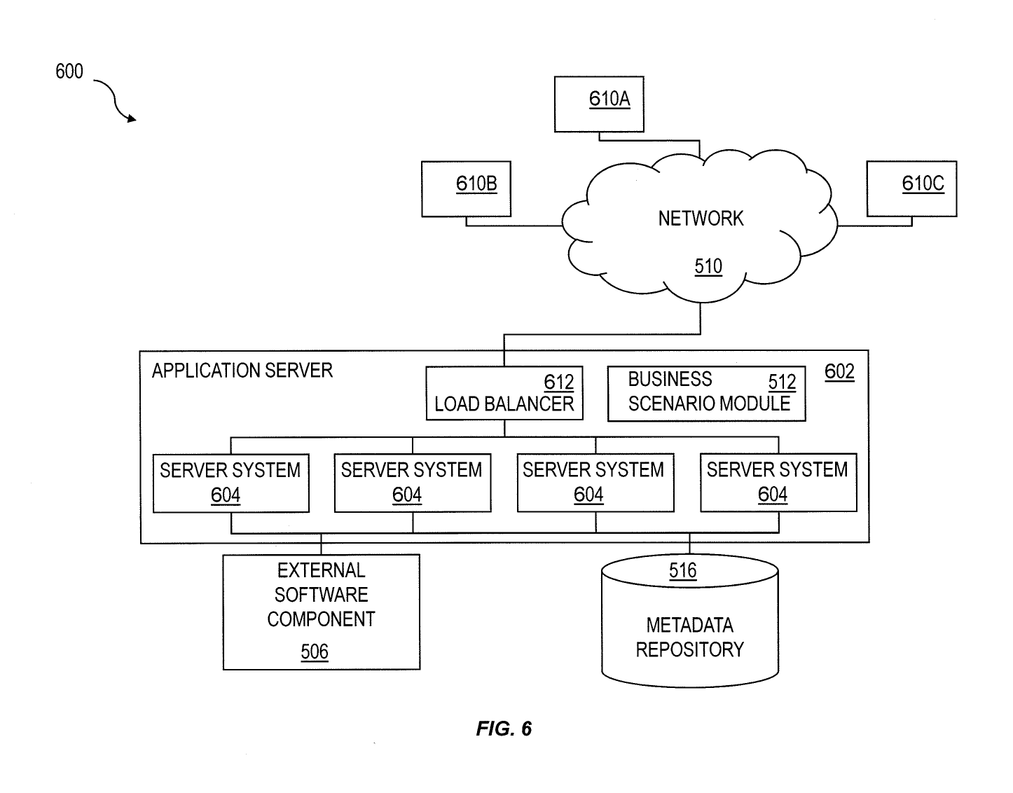

FIG. 6 shows a block diagram of a multi-tenant implementation of a software delivery architecture 600 that includes an application server 602, which can in some implementations include multiple server systems 604 that are accessible over a network 510 from client machines operated by users at each of multiple organizations 610A-610C (referred to herein as “tenants” of a multi-tenant system) supported by a single software delivery architecture 600. For a system in which the application server 602 includes multiple server systems 604, the application server can include a load balancer 612 to distribute requests and actions from users at the one or more organizations 610A-610C to the one or more server systems 604. Instances of the core software platform 504 (not shown in FIG. 6) can be executed in a distributed manner across the server systems 604. A user can access the software delivery architecture across the network 510 using a thin client, such as for example a web browser or the like, or other portal software running on a client machine. The application server 602 can access data and data objects stored in one or more data repositories 516. The application server 602 can also serve as a middleware component via which access is provided to one or more external software components 506 that can be provided by third party developers.

A multi-tenant system such as that described herein can include one or more of support for multiple versions of the core software and backwards compatibility with older versions, stateless operation in which no user data or business data are retained at the thin client, and no need for tenant configuration on the central system. As noted above, in some implementations, support for multiple tenants can be provided using an application server 602 that includes multiple server systems 604 that handle processing loads distributed by a load balancer 612. Potential benefits from such an arrangement can include, but are not limited to, high and reliably continuous application server availability and minimization of unplanned downtime, phased updating of the multiple server systems 604 to permit continuous availability (one server system 604 can be taken offline while the other systems continue to provide services via the load balancer 612), scalability via addition or removal of a server system 604 that is accessed via the load balancer 612, and de-coupled lifecycle processes (such as for example system maintenance, software upgrades, etc.) that enable updating of the core software independently of tenant-specific customizations implemented by individual tenants.

As in the example illustrated in FIG. 5, the metadata repository 516 can store a business object that represents a template definition of a standard business process. Each individual tenant 610A-610C can customize that standard template according to the individual business process features specific to business of the organization to which that tenant is assigned. Customizations can be stored as extensions in the metadata repository.

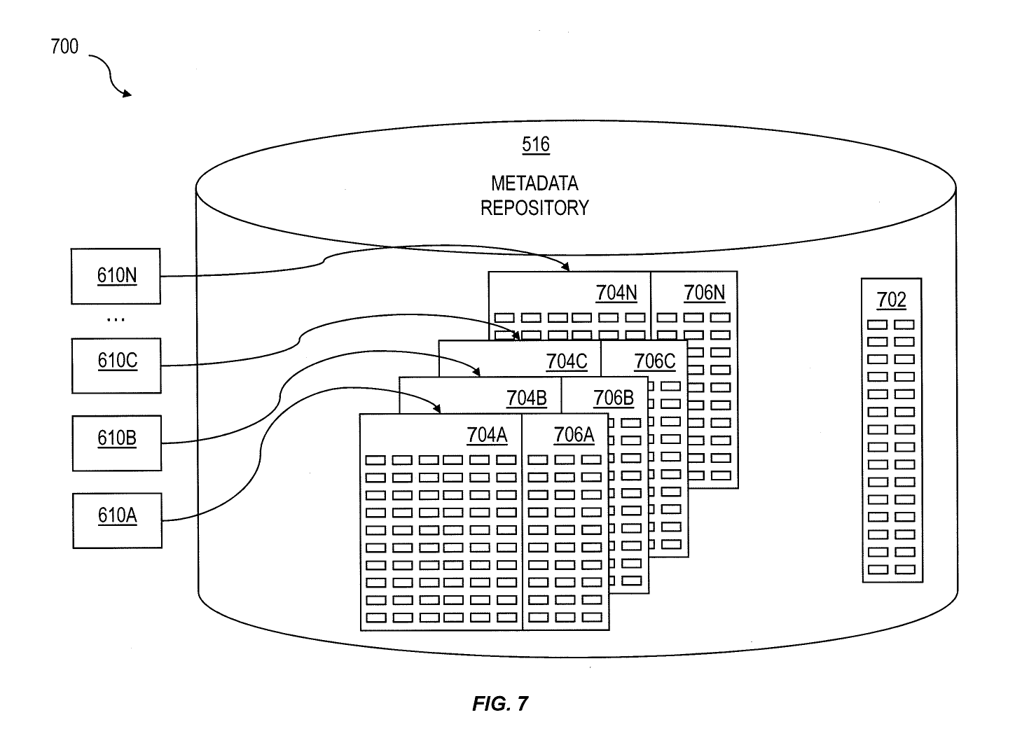

To provide for customization of the business process for each of multiple organizations supported by a single software delivery architecture 600, the data and data objects stored in the metadata repository 516 and/or other data repositories that are accessed by the application server 602 can include three types of content as shown in FIG. 7: core software platform content 702 (e.g. a standard definition of a business process), system content 704 and tenant content 706. Core software platform content 702 includes content that represents core functionality and is not modifiable by a tenant. System content 704 can in some examples be created by the runtime of the core software platform and can include core data objects that store concrete data associated with specific instances of a given business process and that are modifiable with data provided by each tenant. The data retained in these data objects are tenant-specific: for example, each tenant 610A-610N can store information about its own inventory, sales order, etc. Tenant content 706A-706N includes data objects or extensions to other data objects that are customized for one specific tenant 610A-610N to reflect business processes and data that are specific to that specific tenant and are accessible only to authorized users at the corresponding tenant. Such data objects can include a key field (for example “client” in the case of inventory tracking) as well as one or more of master data, business configuration information, transaction data or the like. For example, tenant content 706 can reflect tenant-specific modifications or changes to a standard template definition of a business process as well as tenant-specific customizations of the business objects that relate to individual process step (e.g. records in generated condition tables, access sequences, price calculation results, other tenant-specific values, or the like). A combination of the software platform content 702 and system content 704 and tenant content 706 of a specific tenant are accessed to provide the business process definition and/or the status information relating to a specific instance of the business process according to customizations and business data of that tenant such that each tenant is provided access to a customized solution whose data are available only to users from that tenant.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer program product comprising a machine-readable medium storing instructions that, when executed by at least one programmable processor, cause the at least one programmable processor to perform operations comprising:
accessing a single meta-model that comprises metadata defining a business scenario landscape, the business scenario landscape comprising a plurality of business scenarios accessible to members of an organization and supported by a business software architecture, the metadata comprising business scenario definitions and relationships between business scenarios in the business scenario landscape;
presenting, via a user interface, a first visualization layer based on the metadata, the first visualization layer comprising a plurality of first user interface elements forming a business scenario landscape map showing at least two of the plurality of business scenarios and at least one relationship between the at least two of the plurality of business scenarios;
presenting, via the user interface upon receiving a navigation command entered via one or more of the plurality of first user interface elements, a second visualization layer based on the metadata, the second visualization layer comprising a plurality of second user interface elements displayed in a navigation pane concurrently with a work pane, the plurality of second user interface elements being arranged in a linear progression to represent a linear sequence of a plurality of business processes and/or process steps of one of the plurality of business scenarios, the work pane comprising a plurality of additional user interface elements corresponding to functionality provided by one or more feature modules of the business software architecture related to a currently selected one of the plurality of second business processes and/or process steps.

2. A computer program product as in claim 1, wherein the at least one relationship between the at least two of the plurality of business scenarios comprises one or more of a business scenario intersection relationship, a business scenario dependency relationship, a business scenario prerequisite relationship, and a business scenario predecessor-successor relationship.

3. A computer program product as in claim 1, wherein the plurality of first user interface elements are arranged in the first visualization layer to form a scenario-centric view in which a currently active business scenario of the at least two of the plurality of business scenarios is arranged approximately centrally in a view of the first visualization layer and with those of the plurality of first user interface elements representing the business processes and/or process steps of the currently active business scenario arranged substantially centrally and in a linear succession to show a linear ordering of the business processes and/or process steps and in which others of the at least two of the plurality of business scenarios are arranged to show the at least one relationship to the currently active business scenario.

4. A computer program product as in claim 1, wherein the plurality of first user interface elements are arranged in the first visualization layer to form a transit map view of the business scenario landscape in which each of the at least two of the plurality of business scenarios are shown as linearized scenarios represented by a plurality of stops each representing a business process and/or process step that is part of one or more of the at least two of the plurality of business scenarios and a linear route linking at least some of those business processes and/or process steps that are part of each of the at least two of the plurality of business scenarios.

5. A computer program product as in claim 1, wherein the single meta-model further comprises at least one of concrete data, detailed instance information, a key performance indicator, configuration information, and an organizational reference, the concrete data, detailed instance information, the key performance indicator, configuration information, and the organizational reference being associated with at least one of an in-progress instance of one of the plurality of business scenarios and a completed instance of one of the plurality of business scenarios, at least one of the plurality of first user interface elements and the plurality of second user interface elements providing a visual indicator of a current status of a corresponding process step in the in-progress and/or completed instance of the business process.

6. A computer program product as in claim 1, wherein the operations further comprise presenting, via the user interface upon receiving a navigation command entered via one or more of the plurality of first user interface elements or one or more of the plurality of second user interface elements, a third visualization layer based on the metadata, the third visualization layer comprising a plurality of third user interface elements arranged to display a full detail view of the currently active business scenario or of a business process within the currently active business scenario.

7. A system comprising:
at least one programmable processor; and
a machine-readable medium storing instructions that, when executed by the at least one programmable processor, cause the at least one programmable processor to perform operations comprising:
accessing a single meta-model that comprises metadata defining a business scenario landscape, the business scenario landscape comprising a plurality of business scenarios accessible to members of an organization and supported by a business software architecture, the metadata comprising business scenario definitions and relationships between business scenarios in the business scenario landscape;
presenting, via a user interface, a first visualization layer based on the metadata, the first visualization layer comprising a plurality of first user interface elements forming a business scenario landscape map showing at least two of the plurality of business scenarios and at least one relationship between the at least two of the plurality of business scenarios;
presenting, via the user interface upon receiving a navigation command entered via one or more of the plurality of first user interface elements, a second visualization layer based on the metadata, the second visualization layer comprising a plurality of second user interface elements displayed in a navigation pane concurrently with a work pane, the plurality of second user interface elements being arranged in a linear progression to represent a linear sequence of a plurality of business processes and/or process steps of one of the plurality of business scenarios, the work pane comprising a plurality of additional user interface elements corresponding to functionality provided by one or more feature modules of the business software architecture related to a currently selected one of the plurality of second business processes and/or process steps.

8. A system as in claim 7, wherein the at least one relationship between the at least two of the plurality of business scenarios comprises one or more of a business scenario intersection relationship, a business scenario dependency relationship, a business scenario prerequisite relationship, and a business scenario predecessor-successor relationship.

9. A system as in claim 7, wherein the plurality of first user interface elements are arranged in the first visualization layer to form a scenario-centric view in which a currently active business scenario of the at least two of the plurality of business scenarios is arranged approximately centrally in a view of the first visualization layer and with those of the plurality of first user interface elements representing the business processes and/or process steps of the currently active business scenario arranged substantially centrally and in a linear succession to show a linear ordering of the business processes and/or process steps and in which others of the at least two of the plurality of business scenarios are arranged to show the at least one relationship to the currently active business scenario.

10. A system as in claim 7, wherein the plurality of first user interface elements are arranged in the first visualization layer to form a transit map view of the business scenario landscape in which each of the at least two of the plurality of business scenarios are shown as linearized scenarios represented by a plurality of stops each representing a business process and/or process step that is part of one or more of the at least two of the plurality of business scenarios and a linear route linking at least some of those business processes and/or process steps that are part of each of the at least two of the plurality of business scenarios.

11. A system as in claim 7, wherein the single meta-model further comprises at least one of concrete data, detailed instance information, a key performance indicator, configuration information, and an organizational reference, the concrete data, detailed instance information, the key performance indicator, configuration information, and the organizational reference being associated with at least one of an in-progress instance of one of the plurality of business scenarios and a completed instance of one of the plurality of business scenarios, at least one of the plurality of first user interface elements and the plurality of second user interface elements providing a visual indicator of a current status of a corresponding process step in the in-progress and/or completed instance of the business process.

12. A system as in claim 7, wherein the operations further comprise presenting, via the user interface upon receiving a navigation command entered via one or more of the plurality of first user interface elements or one or more of the plurality of second user interface elements, a third visualization layer based on the metadata, the third visualization layer comprising a plurality of third user interface elements arranged to display a full detail view of the currently active business scenario or of a business process within the currently active business scenario.

13. A computer-implemented method comprising:
accessing a single meta-model that comprises metadata defining a business scenario landscape, the business scenario landscape comprising a plurality of business scenarios accessible to members of an organization and supported by a business software architecture, the metadata comprising business scenario definitions and relationships between business scenarios in the business scenario landscape;
presenting, via a user interface, a first visualization layer based on the metadata, the first visualization layer comprising a plurality of first user interface elements forming a business scenario landscape map showing at least two of the plurality of business scenarios and at least one relationship between the at least two of the plurality of business scenarios;
presenting, via the user interface upon receiving a navigation command entered via one or more of the plurality of first user interface elements, a second visualization layer based on the metadata, the second visualization layer comprising a plurality of second user interface elements displayed in a navigation pane concurrently with a work pane, the plurality of second user interface elements being arranged in a linear progression to represent a linear sequence of a plurality of business processes and/or process steps of one of the plurality of business scenarios, the work pane comprising a plurality of additional user interface elements corresponding to functionality provided by one or more feature modules of the business software architecture related to a currently selected one of the plurality of second business processes and/or process steps.

14. A computer-implemented method as in claim 13, wherein the at least one relationship between the at least two of the plurality of business scenarios comprises one or more of a business scenario intersection relationship, a business scenario dependency relationship, a business scenario prerequisite relationship, and a business scenario predecessor-successor relationship.

15. A computer-implemented method as in claim 13, wherein the plurality of first user interface elements are arranged in the first visualization layer to form a scenario-centric view in which a currently active business scenario of the at least two of the plurality of business scenarios is arranged approximately centrally in a view of the first visualization layer and with those of the plurality of first user interface elements representing the business processes and/or process steps of the currently active business scenario arranged substantially centrally and in a linear succession to show a linear ordering of the business processes and/or process steps and in which others of the at least two of the plurality of business scenarios are arranged to show the at least one relationship to the currently active business scenario.

16. A computer-implemented method as in claim 13, wherein the plurality of first user interface elements are arranged in the first visualization layer to form a transit map view of the business scenario landscape in which each of the at least two of the plurality of business scenarios are shown as linearized scenarios represented by a plurality of stops each representing a business process and/or process step that is part of one or more of the at least two of the plurality of business scenarios and a linear route linking at least some of those business processes and/or process steps that are part of each of the at least two of the plurality of business scenarios.

17. A computer-implemented method as in claim 13, wherein the single meta-model further comprises at least one of concrete data, detailed instance information, a key performance indicator, configuration information, and an organizational reference, the concrete data, detailed instance information, the key performance indicator, configuration information, and the organizational reference being associated with at least one of an in-progress instance of one of the plurality of business scenarios and a completed instance of one of the plurality of business scenarios, at least one of the plurality of first user interface elements and the plurality of second user interface elements providing a visual indicator of a current status of a corresponding process step in the in-progress and/or completed instance of the business process.

18. A computer-implemented method as in claim 13, further comprising presenting, via the user interface upon receiving a navigation command entered via one or more of the plurality of first user interface elements or one or more of the plurality of second user interface elements, a third visualization layer based on the metadata, the third visualization layer comprising a plurality of third user interface elements arranged to display a full detail view of the currently active business scenario or of a business process within the currently active business scenario.

19. A computer-implemented method as in claim 13, wherein at least one of the accessing, the presenting of the first visualization layer, and the presenting of the second visualization layer are performed by at least one programmable processor.
